(19) United States
(12) Patent Application Publication
(10) Pub. No.: US 2025/0305721 A1
(43) Pub. Date: Oct. 2, 2025

(54) Self-Powered Hot Water Heater Device and Method of Use

(71) Applicant: David Brooks, Harrisburg, PA (US)

(72) Inventor: David Brooks, Harrisburg, PA (US)

(21) Appl. No.: 18/760,223

(22) Filed: Jul. 1, 2024

Related U.S. Application Data
(60) Provisional application No. 63/570,277, filed on Mar. 27, 2024.

(51) Int. Cl. F24H 1/10; F03B 7/00; F24H 15/128; H02K 7/18

(52) U.S. Cl. CPC F24H 1/102; F03B 7/00; F24H 15/128; H02K 7/1823; F05B 2220/7064

(57) ABSTRACT

A self-powered hot water heater capable of heating water without external electricity is disclosed. The heater device includes an insulated, sealed housing, preferably cuboidal, with inlet and outlet ports for flow of water. A magnetic paddle wheel is disposed within the housing and rotates by water inflow. The wheel is equipped with outwardly extending paddles and a central magnetic core that generates a magnetic field. When the magnetic field is cut through by the paddles, voltage is induced in windings through electromagnetic induction. A copper tubing inside the housing is wrapped in resistance wire and is connected to the windings. The tubing uses the induced voltage to heat water as the water moves from the inlet port to the outlet port. The system also includes a voltage controller that converts AC to DC and features an automatic cut-off to prevent overheating.

### CROSS-REFERENCE TO RELATED APPLICATION

The present application claims priority to, and the benefit of, U.S. Provisional Application No. 63/570,277, which was filed on Mar. 27, 2024, and is incorporated herein by reference in its entirety.

### FIELD OF THE INVENTION

The present invention relates generally to the field of water heaters. More specifically, the present invention relates to a novel self-powered hot water heater designed to provide hot water without the use of electricity. The device includes a paddle wheel, windings, and a copper tubing wrapped in resistance wire. The paddle wheel rotates by water inflow and includes outwardly extending paddles and a central magnetic core that generates a magnetic field. When a magnetic field is cut through by the paddles, voltage is induced in windings through electromagnetic induction. The tubing uses the induced voltage to heat water as the water moves from the inlet to the outlet. Accordingly, the present disclosure makes specific reference thereto. Nonetheless, it is to be appreciated that aspects of the present invention are also equally applicable to other like applications, devices, and methods of manufacture.

### BACKGROUND

By way of background, electric water heaters are used by everyone to heat water whenever required, and conventional water heaters are completely dependent on a consistent and reliable power supply to function properly. However, there are many scenarios when hot water is needed, but electricity is unavailable to run a hot water heater such as when someone is camping, in a military location, or in a third world country. Additionally, in case of a power outage or disruption, individuals are unable to use their water heaters. Without a proper power supply, the existing water heaters are of no use to the users.

Since conventional water heaters are completely dependent on electrical power supply, these heaters can be expensive for the users and can lead to high electricity bills. Individuals who need water heaters all the time may be unable to use it due to higher energy costs. Not all individuals can afford these water heaters and may require heaters that do not lead to high energy costs.

Further, due to the dependency of heaters on continuous power supply, the conventional water heaters need to be plugged into an electrical outlet during the time of use that eventually restricts the mobility of the heaters. Individuals may have to keep the water heater at a place near the electrical outlet and cannot shift the heater from one location to another as per their desires. Furthermore, existing electric water heaters can pose safety risks for children and adults as an individual can get an electric shock due to faulty water heaters. Individuals can get injured or may lose their lives due to malfunctioning water heaters.

Therefore, there exists a long-felt need in the art for a water heater that is not dependent on consistent electrical power supply. There is also a long-felt need in the art for an improved water heater that is not required to be plugged into an electrical outlet for functioning of the water heater. Additionally, there is a long-felt need in the art for an improved water heater that is portable and that can be moved from one location to another, without considering the position of electrical outlet for providing power supply to heaters. Moreover, there is a long-felt need in the art for an enhanced water heater that can be easily used in locations where electricity is usually unavailable, for example, while going camping, in a military location, or in a third world country. Moreover, there is a long-felt need in the art for a water heater that can work even during power outages and that does not rely on power supply for its functioning. Further, there is a long-felt need in the art for a water heater that does not lead to high electricity bills and is affordable by all individuals. Furthermore, there is a long-felt need in the art for a water heater that can be safely used by children and adults, without any safety risks of electric shocks and injuries. Finally, there is a long-felt need in the art for a modified water heater that is easy to use, safe, affordable, and portable.

The subject matter disclosed and claimed herein, in one embodiment thereof, comprises a self-powered hot water heater. The heater features sealed housing, the housing includes an inlet port for receiving water from an external water source. A magnetic paddle wheel is included inside the housing and is adapted to rotate upon inflow of water through the inlet port. The paddle wheel includes a plurality of paddles. A magnetic core is configured to produce a magnetic field, wherein rotation of the paddle wheel induces a voltage in windings through electromagnetic induction. A copper tubing is disposed within the housing, the tubing is wrapped with resistance wire, wherein the induced voltage heats the resistance wire to warm water passing through the copper tubing from the inlet port to an outlet port.

In this manner, the self-powered hot water heater of the present invention accomplishes all of the foregoing objectives and provides users with a water heating system that operates without external electricity and reduces the carbon footprint compared to traditional electric or gas water heaters. The device is a sustainable and eco-friendly solution, particularly for areas with unreliable electricity supply or in off-grid applications. The device has a weatherproof design and can be mounted on walls or placed on floors making it adaptable for different settings, including both residential and commercial environments.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-powered hot water heater. The heater further comprises an insulated and sealed housing, the housing includes an inlet port adapted to receive water from an external water source. A magnetic paddle wheel is positioned within the housing and is adapted to rotate upon inflow of water through the inlet port. The paddle wheel includes a plurality of paddles extending transversally from the central body of the paddle wheel. A magnetic core is disposed within the paddle wheel and is configured to produce a magnetic field, wherein rotation of the paddle wheel induces a voltage in nearby windings through electromagnetic induction. A copper tubing is disposed within the housing, the tubing being wrapped with resistance wire and is operatively connected to the windings, wherein the induced voltage heats the resistance wire to warm water passing through the copper tubing from the inlet port to an outlet port on the same side of the housing.

In yet another embodiment, a method for heating water in a self-powered water heater is described. The method includes the steps of receiving water into an insulated and sealed housing through an inlet port, rotating a magnetic paddle wheel disposed within the housing by flow of the received water, wherein the paddle wheel includes a plurality of outwardly extending paddles, generating a magnetic field using a magnetic core integrated into the paddle wheel, inducing a voltage in windings through electromagnetic induction caused by interaction between the rotating paddles and the magnetic core, transmitting the induced voltage to resistance wire wrapped around copper tubing within the housing, and heating water as it flows from the inlet port to an outlet port through the heated copper tubing.

In yet another embodiment, a self-powered hot water heater system is disclosed. The system includes a cuboidal housing with an inlet port and an outlet port disposed on a side wall, the inlet port is adapted to facilitate inflow of water, and the outlet port is adapted to eject heated water, a magnetic paddle wheel within the housing is configured to rotate in response to water inflow, the paddle wheel includes paddles and a magnetic core for generating a controlled magnetic field upon rotation, electrical windings are positioned to interact magnetically with the paddle wheel for generating voltage through electromagnetic induction, and a continuous copper tubing is wrapped in resistance wire and is adapted to receive the generated voltage to heat water as the water passes through the tubing.

In yet another embodiment, a voltage controller is coupled to the windings, the controller is adapted to convert alternating current (AC) to direct current (DC) and to automatically cut off power to resistance wire wrapped around copper tubing when a predefined threshold temperature is exceeded.

In another aspect, the housing is weatherproof and configured for outdoor installation, and the inlet port is directly connectable to a continuous water source to ensure a consistent flow rate sufficient to maintain the operation of the magnetic paddle wheel.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a self-powered water heater device of the present invention in accordance with the disclosed architecture;

FIG. 2 illustrates a schematic view showing the connection of different components of the self-powered water heater of the present invention in accordance with the disclosed structure;

FIG. 3A illustrates a perspective view showing the magnetic core of the heater device in accordance with one embodiment of the present invention;

FIG. 3B illustrates a perspective view showing the windings and the controller of the heater device in accordance with one embodiment of the present invention;

FIG. 4 illustrates a rear perspective view of the self-powered water heater device of the present invention in accordance with the disclosed architecture; and

FIG. 5 illustrates a perspective view showing installation of the self-powered thermal energy generator of the present invention in a commercial setting in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a water heater that is not dependent on consistent electrical power supply. There is also a long-felt need in the art for an improved water heater that is not required to be plugged into an electrical outlet for functioning of the water heater. Additionally, there is a long-felt need in the art for an improved water heater that is portable and that can be moved from one location to another, without considering the position of electrical outlet for providing power supply to heaters. Moreover, there is a long-felt need in the art for an enhanced water heater that can be easily used in locations where electricity is usually unavailable, for example, while going camping, in a military location, or in a third world country. Moreover, there is a long-felt need in the art for a water heater that can work even during power outages and that does not rely on power supply for its functioning. Further, there is a long-felt need in the art for a water heater that does not lead to high electricity bills and is affordable by all individuals. Furthermore, there is a long-felt need in the art for a water heater that can be safely used by children and adults, without any safety risks of electric shocks and injuries. Finally, there is a long-felt need in the art for a modified water heater that is easy to use, safe, affordable, and portable.

The present invention, in one exemplary embodiment, is a self-powered hot water heater system. The system includes a housing with an inlet port and an outlet port, the inlet port is adapted to facilitate inflow of water, and the outlet port is adapted to eject heated water, a magnetic paddle wheel within the housing is configured to rotate in response to water inflow, the paddle wheel includes paddles and a magnetic core for generating a magnetic field upon rotation, electrical windings are positioned to interact magnetically with the paddle wheel for generating voltage through electromagnetic induction, and a continuous copper tubing is wrapped in resistance wire and is adapted to receive the generated voltage to heat water as the water passes through the tubing.

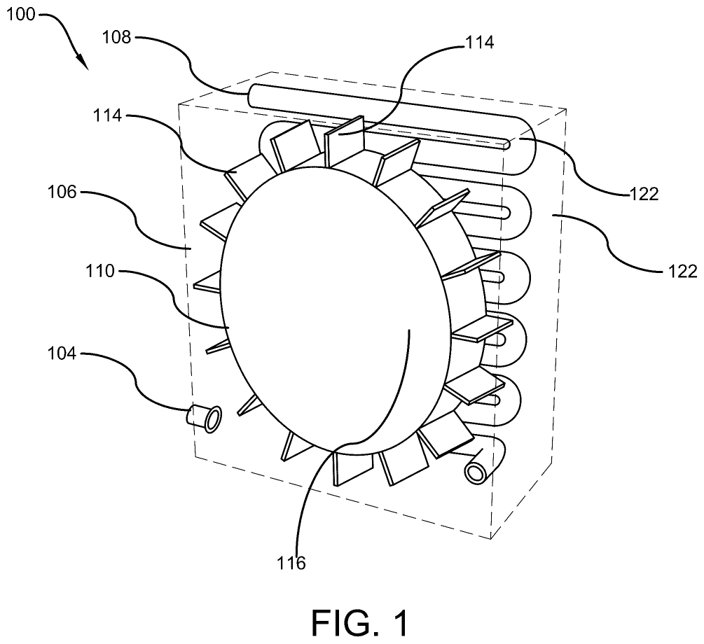

Referring initially to the drawings, FIG. 1 illustrates a perspective view of a self-powered water heater device of the present invention in accordance with the disclosed architecture. The self-powered hot water heater 100 of the present invention is designed to heat water without relying on external electricity and to enable users to have access to warm or hot water when electricity is unavailable. More specifically, the self-powered hot water heater 100 includes an insulated and sealed housing 102 which can be of any geometric shape and size and is preferably cuboidal. The housing 102 includes an inlet port 104 on a side wall 106 of the housing 102. The inlet port 104 is adapted to inflow water from an external water source into the housing 102 for heating.

An outlet port 108 is disposed on the same side wall 106 and is adapted to provide hot water, wherein the water is heated using the self-powered hot water heater 100. The housing 102 can be placed on a floor or can also be mounted to a wall as per preferences of users. Further, the self-powered hot water heater 100 can be used for both personal and commercial purposes.

The housing 102 includes a magnetic paddle wheel 110 configured to rotate when water from the inlet port 104 flows through the wheel 110. The paddle wheel 110 includes a plurality of paddles 114 wherein each paddle extends transversal outwardly from the main circular body 116 of the wheel 110. The magnetic paddle wheel 110 functions as a turbine and also helps in rotation of the water inside the housing 102 which in turn helps in further rotation of the paddle wheel 110.

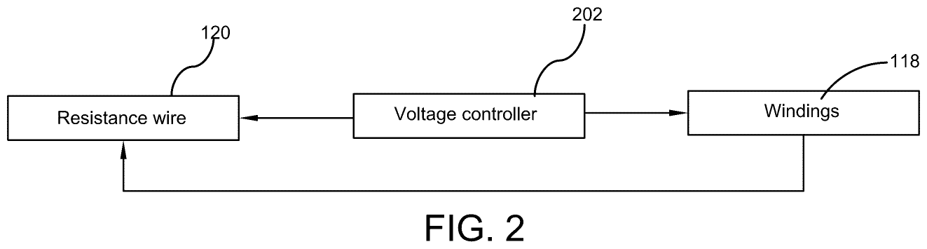

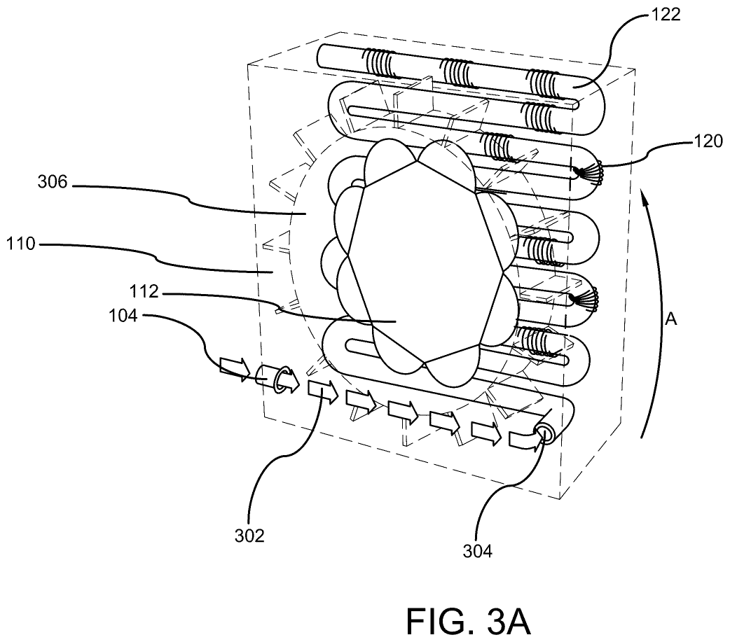

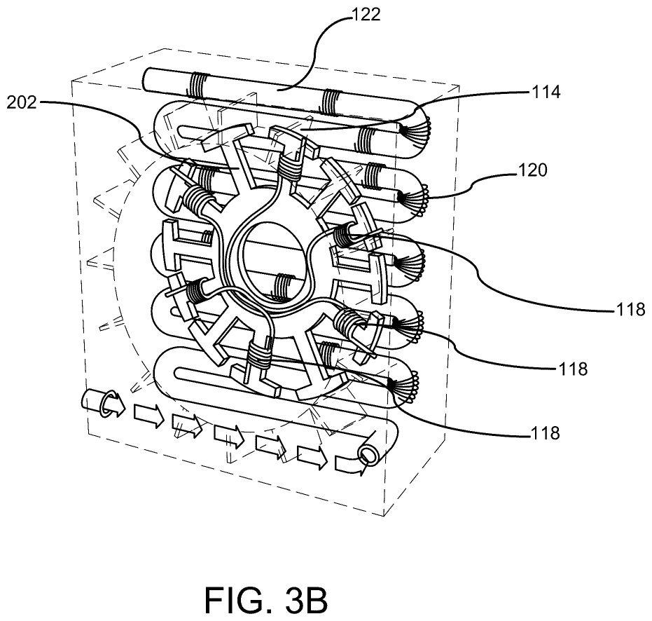

Referring to FIGS. 3A and 3B, a magnetic core 112 (FIG. 3A) is disposed inside the paddle wheel 110 and is used for producing a strong and controlled magnetic field 306. When the paddle wheel 110 rotates, the paddles 114 intercept or cut through the magnetic field produced by the magnetic core 112. When the magnetic field is cut-through, the process of electromagnetic induction takes place and a voltage is induced in the windings 118. The windings 118 are associated with a controller as illustrated in FIG. 2 for controlling voltage generated in the windings 118.

The voltage from the windings 118 passes through at least one resistance wire 120 which is wrapped around a copper tubing 122. The copper tubing 122 is disposed inside the housing 102 and is configured to carry the water from the inlet port 104 to the outlet port 108. The copper tubing 122 is a single continuous tube and is operatively connected to the windings 118 for heating the resistance wire 120 to heat the water passing through the copper tubing 122. Preferably, the copper tubing 122 adheres to the rear surface 124 of the housing 102 but can also be positioned in any desired position inside the housing 102. The resistance wire 120 preferably covers more than 85% surface area of the copper tubing 122, in other embodiments the resistance wire 120 covers more than 98% surface area of the copper tubing 122.

FIG. 2 illustrates a schematic view showing the connection of different components of the self-powered water heater of the present invention in accordance with the disclosed structure. As illustrated, a voltage controller 202 is coupled to the windings 118 and is adapted to convert the alternating current (AC) produced by the windings 118 into direct current (DC) before passing to the resistance wire 120 for heating water. The voltage controller 202 is also configured to automatically cut-off power supply to the resistance wire 120 when the temperature of the windings 118 or the resistance wire 120 increases beyond a predefined threshold temperature value.

FIGS. 3A and 3B illustrate perspective views showing movement of water and the paddle wheel inside the housing in accordance with one embodiment of the present invention. As illustrated, water flows from the inlet port 104 inside the housing 102 to rotate the paddle wheel 110 in a clockwise direction (Arrow A). As the paddle wheel 110 rotates, the water 302 moves through the input end 304 of the copper tubing 122 into the tube 122. The process of electromagnetic induction starts and the paddles 114 cut-through the magnetic field 306 produced by the magnetic core 112. The windings 118 generate electric voltage and the voltage is passed to the resistance wire 120. The windings 118 as shown in FIG. 3B are disposed underneath the magnetic core 112 and are disposed between the magnetic core 112 and the controller module 202.

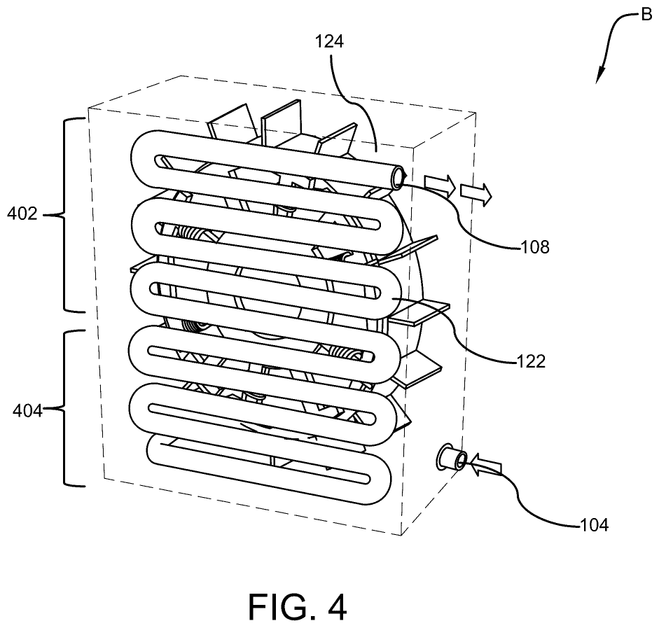

As illustrated in FIG. 4, the copper tubing 122 becomes hot (Arrow B) using the resistance wire 120 disposed thereon, and preferably, the temperature of the upper members 402 of the copper tube 122 is more (i.e., higher) than the temperature of the lower members 404 of the copper tube 122. The hot water automatically ejects from the outlet port 108.

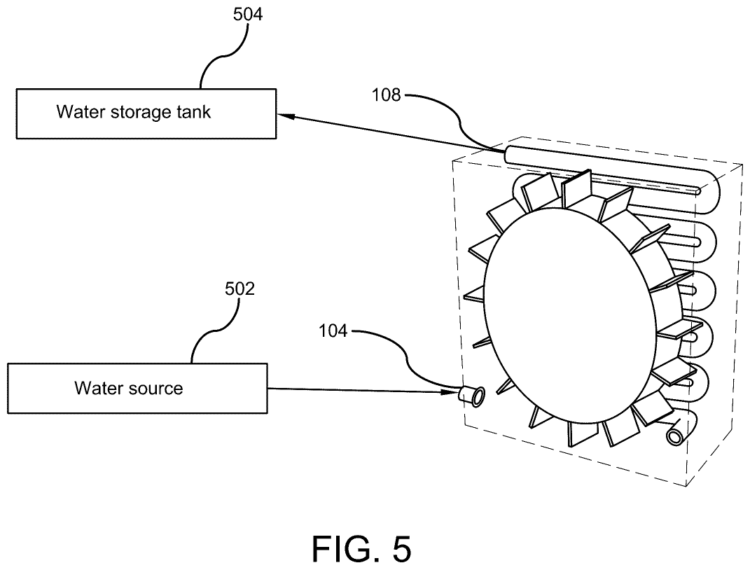

FIG. 5 illustrates a perspective view showing installation of the self-powered thermal energy generator of the present invention in a commercial setting in accordance with one embodiment of the present invention. As illustrated, inlet port 104 of the water heater 100 is connected to a water source 502 for providing adequate flow of water into the heater 100. The outlet port 108 is coupled to a water storage tank 504 for receiving and storing hot water from the heater 100. The water heater device 100 is automatically activated when water is received from the inlet port 104. The housing 102 is weatherproof and can be installed outdoors.

In another embodiment of the present invention, a method for heating water using the self-powered water heater 100 is described. The method includes receiving water into an insulated and sealed housing through the inlet port 104, rotating the magnetic paddle wheel 110 disposed within the housing 102 by flow of the received water, wherein the paddle wheel 110 includes a plurality of outwardly extending magnetic paddles 114, generating a magnetic field using a magnetic core integrated into the paddle wheel, inducing a voltage in windings 118 through electromagnetic induction caused by interaction between the rotating magnetic paddles and the magnetic core, transmitting the induced voltage to resistance wire 120 wrapped around copper tubing 122 within the housing 102, and heating water as it flows from the inlet port 104 to the outlet port 108 through the heated copper tubing 122.

The self-powered thermal energy generator 100 does not require external electricity for the operation making it potentially beneficial in remote areas or for eco-friendly applications.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “self-powered thermal energy generator”, “self-powered water heater”, “water heater device”, and “heater” are interchangeable and refer to the self-powered water heater device 100 of the present invention.

Notwithstanding the foregoing, the self-powered water heater device 100 of the present invention can be of any suitable size and configuration as is known in the art without affecting the overall concept of the invention, provided that it accomplishes the above-stated objectives. One of ordinary skill in the art will appreciate that the self-powered water heater device 100 as shown in the FIGS. are for illustrative purposes only, and that many other sizes and shapes of the self-powered water heater device 100 are well within the scope of the present disclosure. Although the dimensions of the self-powered water heater device 100 are important design parameters for user convenience, the self-powered water heater device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-powered hot water heater comprising:
a hot water heater housing having an inlet port, an outlet port, and a side wall;
a magnetic paddle wheel having a circular body and a plurality of paddles;
a magnetic core;
a plurality of windings;
a voltage controller;
a resistance wire; and
a copper tubing;
wherein said inlet port having an inflow of unheated water from an external water source into said hot water heater housing;
wherein said outlet port having an outflow of heated water;
wherein said magnetic paddle wheel rotatable;
wherein each of said plurality of paddles extend transversal outwardly from said circular body;
wherein said magnetic core is disposed inside said magnetic paddle wheel creating a magnetic field;
wherein said plurality of paddles intercept said magnetic field during rotation of said magnetic paddle wheel producing electromagnetic induction and a voltage induced in said plurality of windings; and
further wherein said voltage controller controlling said voltage generated in said plurality of windings.

2. The self-powered hot water heater of claim 1, wherein said voltage from said plurality of windings passes through said resistance wire.

3. The self-powered hot water heater of claim 1, wherein said resistance wire is wrapped around said copper tubing.

4. The self-powered hot water heater of claim 1, wherein said copper tubing is disposed inside said hot water heater housing.

5. The self-powered hot water heater of claim 1, wherein said copper tubing carries the water from said inlet port to said outlet port.

6. The self-powered hot water heater of claim 1, wherein said copper tubing is a single continuous tube and is operatively connected to said plurality of windings for heating said resistance wire and the water passing through said copper tubing.

7. The self-powered hot water heater of claim 6, wherein said plurality of windings cover at least 85% of a surface area of said copper tubing.

8. The self-powered hot water heater of claim 6, wherein said plurality of windings cover at least 98% of a surface area of said copper tubing.

9. The self-powered hot water heater of claim 7, wherein said housing is a sealed insulated housing.

10. The self-powered hot water heater of claim 1, wherein said voltage controller coupled to said plurality of windings and converts AC from said plurality of windings into DC.

11. A self-powered hot water heater comprising:
a hot water heater housing having an inlet port, an outlet port, and a side wall;
a magnetic paddle wheel having a circular body and a plurality of paddles;
a magnetic core;
a plurality of windings;
a voltage controller;
a resistance wire; and
a copper tubing;
wherein said inlet port having an inflow of unheated water from an external water source into said hot water heater housing;
wherein said outlet port having an outflow of heated water;
wherein said magnetic paddle wheel rotatable;
wherein each of said plurality of paddles extend transversal outwardly from said circular body;
wherein said magnetic core is disposed inside said magnetic paddle wheel creating a magnetic field;
wherein said plurality of paddles intercept said magnetic field during rotation of said magnetic paddle wheel producing electromagnetic induction and a voltage induced in said plurality of windings;
wherein said voltage controller controlling said voltage generated in said plurality of windings;
wherein said copper tubing carries the water from said inlet port to said outlet port; and
further wherein said copper tubing is a single continuous tube and is operatively connected to said plurality of windings for heating said resistance wire and the water passing through said copper tubing.

12. The self-powered hot water heater of claim 11, wherein said voltage from said plurality of windings passes through said resistance wire.

13. The self-powered hot water heater of claim 11, wherein said resistance wire is wrapped around said copper tubing.

14. The self-powered hot water heater of claim 11, wherein said plurality of windings cover at least 85% of a surface area of said copper tubing.

15. The self-powered hot water heater of claim 11, wherein said plurality of windings cover at least 98% of a surface area of said copper tubing.

16. The self-powered hot water heater of claim 11, wherein said housing is a sealed insulated housing.

17. The self-powered hot water heater of claim 11, wherein said voltage controller coupled to said plurality of windings and converts AC from said plurality of windings into DC.

18. A method for heating water, the method comprising the steps of:
providing a hot water heater housing having an inlet port, an outlet port, and a side wall; a magnetic paddle wheel having a circular body and a plurality of magnetic paddles; a magnetic core; a plurality of windings; a voltage controller; a resistance wire; and a copper tubing;
flowing unheated water into said inlet port from an external water source into said hot water heater housing;
rotating said magnetic paddle wheel;
extending each of said plurality of magnetic paddles transversally outward from said circular body;
mounting said magnetic core inside said magnetic paddle wheel and creating a magnetic field;
intercepting said magnetic field with said plurality of magnetic paddles during rotation of said magnetic paddle wheel producing electromagnetic induction and a voltage induced in said plurality of windings;
controlling said voltage generated in said plurality of windings with said voltage controller;
carrying the water from said inlet port to said outlet port through said copper tubing, wherein said copper tubing is a single continuous tube and is operatively connected to said plurality of windings for heating said resistance wire and the water passing through said copper tubing; and
flowing heated water out of said outlet port.

19. The method for heating water of claim 18, wherein said voltage from said plurality of windings passes through said resistance wire.

20. The method for heating water of claim 19, wherein said resistance wire is wrapped around said copper tubing, and further wherein said plurality of windings cover at least 85% of a surface area of said copper tubing.
